(19) United States
(12) Patent Application Publication
(10) Pub. No.: US 2009/0314848 A1
(43) Pub. Date: Dec. 24, 2009

(54) Radiant Heating System and Method

(75) Inventor: Jan Olof Andersson, Maple Grove, MN (US)

Correspondence Address: PATENT DEPARTMENT;LARKIN, HOFFMAN, DALY & LINDGREN, LTD., 1500 WELLS FARGO PLAZA, 7900 XERXES AVENUE SOUTH, BLOOMINGTON, MN, 55431, US

(73) Assignee: Uponor, Inc., Apple Valley, MN (US)

(21) Appl. No.: 12/066,753

(22) PCT Filed: Sep. 14, 2006
(86) PCT No.: PCT/US06/35678

§ 371 Date: Aug. 19, 2008

Related U.S. Application Data
(60) Provisional application No. 60/716,999, filed on Sep. 14, 2005.

(51) Int. Cl. F24D 3/12; F24D 19/02; B23P 11/00; F24D 19/06

(52) U.S. Cl. 237/71; 29/428; 165/56

(57) ABSTRACT

The present invention relates generally to a radiant heating assembly, system and method. One or more elongate thermally insulative panels are coupled to one or more elongate structural members wherein each such panel assembly may be placed adjacent or in longitudinal alignment with another such panel assembly. The structural members are configured to extend longitudinally and/or recess longitudinally with respect to the structural members for assisting in longitudinal alignment thereof. The thermally insulative panels may include a radiant heating element received on a surface thereof. A tubing for transporting heated water or electrical energy may be received by the radiant heating element for delivering heat therethrough. One or more edge panels may be positioned at a longitudinal edge of the thermally insulative panels wherein a groove in a surface thereof provides for the delivery of the tubing from one thermally insulative panel to another.

### CROSS-REFERENCE TO RELATED APPLICATIONS

This application claims priority to Provisional Application No. 60/716,999 filed Sep. 14, 2005, which is incorporated herein in its entirety.

### BACKGROUND

Radiant heating is an increasingly popular alternative to forced air heating for homes and business alike due to a more uniform distribution of heat, lower operational cost, and capacity to warm surfaces that otherwise feel cold to the touch, such as wood, tile or stone flooring. A radiant heating system can be installed as part of a laminar floor construction, with a heat radiating layer interposed between a subfloor and a top cover or finished layer. In one type of system, the heating layer consists mainly of electrically conductive heating elements held in place by a fabric mat or other supporting structure. In another approach, known as hydronic radiant heating, flexible tubes or conduits distributes hot water throughout the heating layer. Heat is conducted from the water to metal plates, sheets or foil in contact with the tubing, then radiated by the metal component.

The heating components, either electric elements or hot water tubing, can be embedded in wet concrete or another matrix when installed. In an alternative “dry installation” technique, prefabricated modular panels incorporating channels for supporting and guiding the hot water tubing are secured directly to the subfloor or wall. This approach is described in U.S. Pat. No. 5,292,065 to Fiedrich. According to a more recent improvement disclosed in U.S. Pat. No. 6,270,016 also to Fiedrich, separate panels are coupled to each other by hinges, either side by side or end to end. The foregoing referenced Fiedrich '065 and Fiedrich '016 patents are hereby incorporated herein by reference.

According to another known dry installation approach, hydronic radiant heating panels consist of an expanded foam base molded with grooves in its top or outer surface, and a metal sheet or plate formed with channels corresponding to the grooves for a conforming fit of the plate against the top surface of the base. The channels are sized to receive the hot water conduit. The expanded foam base is thermally insulative. As a result, more of the radiated heat is directed upwardly or outwardly into the room for more effective and efficient use of the heat. However, the expanded foam lacks the strength of wood and other structural materials. It is more susceptible to damage from concentrated forces due to screws or other fasteners. In fact, screws or other fasteners preferably are installed through the metal plate as well as the base, with the plate being better suited to withstand the screw force. Consequently, a relatively thick and rigid metal plate is required. Further, the expanded foam base is not well suited for use as an anchor for securing the cover or finished layer.

### SUMMARY

The present invention addresses the foregoing problems while retaining the benefits that arise from using expanded foam. In addition, the invention provides a heating panel assembly with a folded configuration suitable for transportation and storage, and provides a more convenient method of installing a radiant heating system.

According to the invention, a radiant heating panel assembly includes a plurality of thermally insulative panels. Each panel is elongate in a longitudinal direction and has an obverse panel service, a reverse panel service, and a panel thickness defined by a transverse distance between the obverse and reverse panel surfaces. The obverse surface is contoured to accommodate a radiant heating element. The panel assembly also includes a plurality of structural members. Each structural member is elongate in a longitudinal direction and has an obverse structural member surface, a reverse structural member surface, and a structural member thickness determined by a transverse distance between the obverse and reverse structural member surfaces. The panel assembly further includes a coupling structure adapted to support the panels and the structural members in a working configuration, in which the longitudinal directions of the panels and structural members are substantially parallel, and the reverse panel surfaces and reverse structural member surfaces are substantially coplanar.

The present description is directed primarily to floor installations, in which the reverse panel and structural member surfaces confront the subfloor beneath the panel assembly, and the obverse surfaces of the panels and structural members cooperate to provide a top surface of the assembly. It should be recognized that the present invention is equally applicable to wall or other surface installations, in which case the reverse surfaces confront the wall or other supporting surface.

Typically the obverse surface of each panel is contoured to provide a groove running longitudinally along the panel and recessed inwardly (downwardly in floor installations) from the rest of the obverse surface. This shapes the surface to accommodate a radiant heating element in the form of a metal plate that is generally planar except for a longitudinally running channel. The panel groove accommodates the channel, which in turn accommodates the hot water tubing.

The panels preferably are formed of expanded polystyrene (EPS) or other polymeric foam. The resulting panels are sturdy but lightweight, highly thermally insulative, resistant to moisture and easily shaped by molding to provide the desired obverse surface contour and other features. In addition, expanded foam panels are relatively inexpensive.

The structural members can be formed of a high density polyethylene (HDPE) known as “plastic lumber.” The structural members can bear considerable weight, and can withstand the concentrated forces applied locally by screws or other fasteners. As a result, the panel assembly can be secured to a subfloor of concrete or wood, solely with screws directed through the structural members. There is no need to secure the panels directly with screws, nor is there any need for an adhesive between the assembly and subfloor. Once secured, the structural members provide the lateral stability necessary to secure the panels as well. In addition, the structural members can serve as anchors for securing a covering or finished floor over the panel assembly. The HDPE structural members are resistant to moisture.

The preferred coupling structure is capable of supporting the panels and structural members alternatively in the working configuration, and in a storage or transport configuration in which the panels and structural members are folded against one another in accordion-like fashion. To this end, the coupling structure can include strips of film or tape, each strip running longitudinally and secured to adjacent members, e.g. adjacent panels or a panel and its adjacent structural member. Each strip positions longitudinal side edges of its associated members in contiguous, confronting relation in the working configuration, and acts as a living hinge to allow the adjacent members to pivot relative to each other about a longitudinal axis. Strips can be applied alternatively to obverse surfaces and reverse surfaces of adjacent members, to provide accordion-like folding. If desired, the fastening strips can be metallic, and may contact the radiant heating elements to augment heat conduction and radiation.

In one particularly preferred panel assembly, pairs of the panels are disposed between neighboring structural members. The fastening strips that secure the adjacent panels are applied to their obverse surfaces, while the fastening strips that join panels to adjacent structural members are applied to the respective reverse surfaces.

Another aspect of the present invention is a process for installing a radiant heating system, including the following steps:

(a) providing a panel assembly composed of elongate members coupled side by side, wherein the elongate members include a plurality of thermally insulative panels and a plurality of structural members;

(b) selectively positioning the panel assembly in a working configuration against a subfloor or other selected surface with reverse surfaces of the members confronting and contiguous with the selected surface and with obverse surfaces of members facing away from the selected surface;

(c) with the panel assembly so configured and selectively positioned, installing fasteners through the structural members and into the subfloor, to secure the structural members and the panels against the selected surface; and

(d) mounting radiant heating elements along obverse surfaces of the panels.

Depending on the application, the radiant heating elements may be mounted to the panels after the panel assembly is secured to the subfloor or other selected surface, or in part before securing the assembly. For example, electrical heating elements can be installed after the panel assembly is secured. In hydronic radiant heating systems including such radiant heating elements as metal sheets or plates, and conduit for conducting hot water past the sheets or plates, the plates are advantageously applied to the panels before the panel assembly is secured, while the conduit is best installed after securement.

Although the screws or other fasteners are installed only through the structural members, they secure the entire assembly. There is no need for further screws through the panels, nor for any adhesive between the reverse surfaces and the subfloor or other selected surface. Not only is installation easier, but should the need arise to remove a panel assembly, e.g. for inspection or repair, detachment is accomplished simply by removing the screws. There is no adhesive to contend with, and no resulting damage to the subfloor or panel assembly.

### DESCRIPTION OF THE DRAWINGS

Further features and advantages will become apparent upon consideration of the following detailed description and drawings, in which:

FIG. 1 is a schematic view of a hydronic radiant heating system configured according to the present invention;

FIG. 2 is a sectional view taken along the line 2-2 in FIG. 1;

FIG. 3 is a perspective view showing the panel assembly in a partially folded configuration.

FIG. 4 is a plan view showing portions of two panel assemblies coupled end to end;

FIG. 5 is a plan view showing one of the panel assemblies coupled to an edge panel;

FIG. 6 is a perspective view showing two of the panel assemblies folded and engaged;

FIGS. 7-9 illustrate installation of one of the panel assemblies;

FIG. 10 is an end view of an alternative embodiment panel assembly; and

FIG. 11 is an end view of another alternative embodiment panel structure.

### DETAILED DESCRIPTION

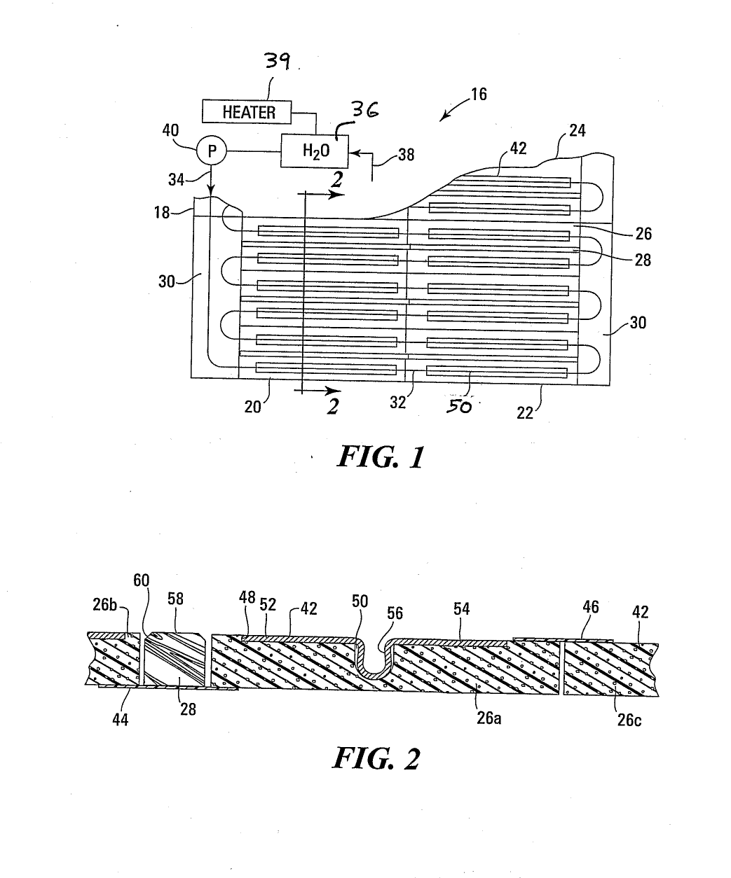

Turning now to the drawings, FIG. 1 shows part of a hydronic radiant heating system 16 suitable for installation over a subfloor, for example, concrete or plywood. Major components of the system include panel assemblies, four of which are shown completely or partially at 18, 20, 22 and 24. Each of the panel assemblies is composed of elongate members including several panels 26 and several anchoring or structural members 28, all coupled together in side by side fashion. Panel assemblies can be coupled to one another end to end or side by side, as needed.

At opposite ends of the system, edge panels 30 are joined to the panel assemblies. Each of the edge panels has arcuate grooves designed for alignment with longitudinal (the horizontal direction in FIG. 1) grooves 50 in panels 26. When the edge panels and panel assemblies are aligned as shown, their respective grooves cooperate to provide a serpentine path for a length of conduit or tubing 32.

The tubing 32 may be any suitable material. In the preferred embodiment, however, the tubing is preferably a flexible tubing, and more specifically, cross-linked polyethylene (PEX) flexible tubing. Tubing 32 includes a supply section 34 coupled to a water supply 36, and a return section 38 through which water is returned to supply 36. A heater 39 heats the water, and a pump 40 circulates the heated water through the conduit to transfer heat from the water to a series of aluminum plates or sheets 42, which, in turn, transfers heat to a cover or finished floor (not shown), that acts as a radiator to heat the room.

FIG. 2 is a partial sectional view of panel assembly 20 taken along a transverse plane through the assembly and showing a panel 26a, one of structural members 28, and portions of panels 26b and 26c. The panel assembly is shown in the installed or working configuration, in which bottom (reverse) surfaces of the panels and structural members are coplanar. In the working configuration, longitudinally extending side surfaces of adjacent panels and structural members are contiguous. Panels 26a and 26b are coupled to structural member 28 by an adhesive backed strip 44 applied to the reverse surfaces of these three components. Strip 44 extends longitudinally for nearly the entire length of the panels and structural member, forming hinges that allow rotation of panels 26a and 26b relative to structural member 28 about longitudinal axes. When the panel assembly is folded, one of panels 26a and 26b remains aligned with the structural member as shown, while the other is pivoted 180 degrees relative to the structural member.

In similar fashion, an adhesive backed strip 46, attached to the obverse surfaces of panel 26a and panel 26c, allows these panels to pivot relative to one another about a longitudinal axis. Complete folding involves rotating panel 26c 180 degrees relative to panel 26a.

Panels 26 preferably are formed of an expanded polymeric foam such as expanded polystyrene (EPS). The panels preferably are formed by injection molding, each with its obverse (top) surface contoured to accommodate a radiant heating element. More particularly, a relatively shallow recess 48 and a U-shaped groove 50 extend longitudinally along the complete length of the panel. These features accommodate an elongate longitudinal extending radiant heating element or plate 42, preferably formed of aluminum or another thermally conductive material. Plate 42 is composed of opposite coplanar side sections 52 and 54, and further is formed to include a central longitudinal channel 56 sized to contain tubing 32 for conducting heated water throughout the system. The inside diameter of channel 56 is slightly larger than the outside diameter of the tubing. However, an upper neck of the channel has a lateral dimension less than the tubing diameter, to require slight elastic compression of the flexible tubing as it is installed into the channel. As a result, the channel is better adapted to contain the tubing. Each plate 42 is attached to its associated panel 26 with an adhesive, applied between side sections 52 and 54 and the panel obverse surface along the flat bottom of recess 48.

Structural members 28 extend longitudinally, and are substantially uniform in lateral cross section. Each structural member is beveled near its obverse surface 58, as indicated at 60. The preferred material for the structural members is a high density polyethylene (HDPE) known as “plastic lumber,” which imparts strength, durability, and moisture resistance.

As seen in FIG. 2, grooves 50 are not laterally centered within their respective panels 26, but are disposed nearer to the panel edge contiguous with one of the structural members. This equalizes the lateral spacing between grooves 50 along the panel assembly. In one particularly preferred arrangement, the panel lateral width is five and one-quarter inches, the structural member lateral width is one and one-half inches, and the center of each groove is spaced two and one-fourth inches from the “support member” side of its associated panel and three inches from the opposite side of the panel. The result is a uniform spacing of six inches between grooves 50 of adjacent panels, regardless of whether a structural member is situated between the adjacent panels.

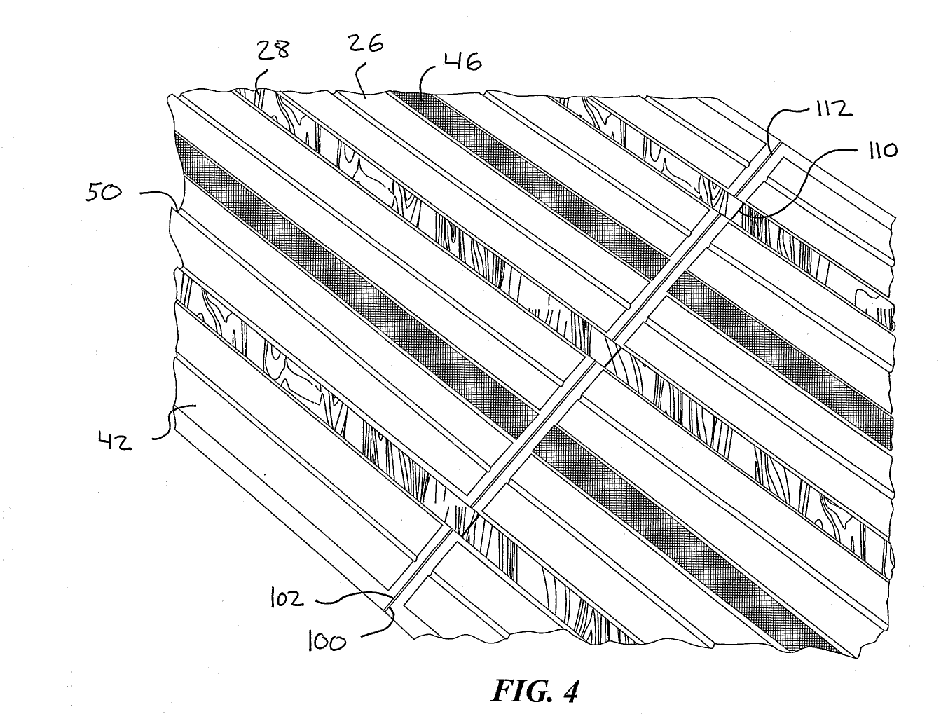

FIG. 4 shows two of the panel assemblies coupled end to end. Each of the panel assemblies includes several thermally conductive sheets or plates 42, with one of the plates mounted to each panel. Each of securing strips 46 is coupled to and positioned between two of the panels. Each panel assembly includes two panel-to-panel junctions where adjacent panels are secured to each other by a strip 46.

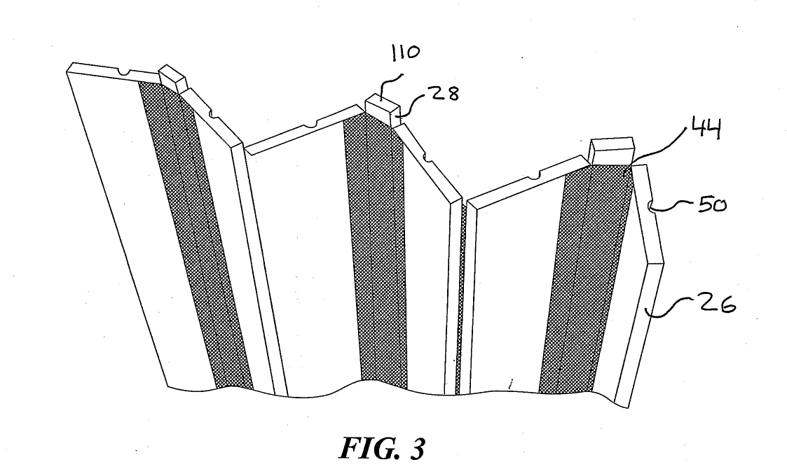

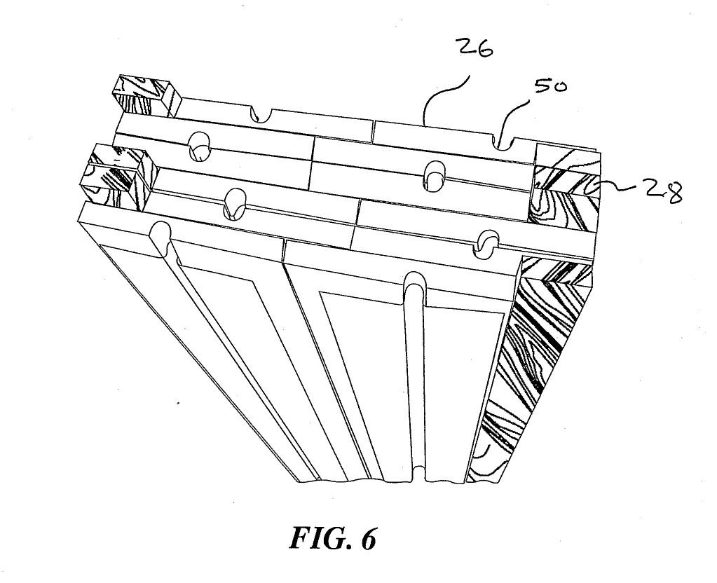

The top of each panel assembly, visible in FIG. 4, is conveniently thought of as the obverse surface. The panels further include bottom or reverse surfaces of panels 26 and structural members 28, which correspond to the bottom surface of the panel assembly. Strips 44 of adhesive backed film or tape extend longitudinally to secure each structural member to its adjacent panels. Strips 44 and 46 function as living hinges, so that adjacent panels and structural members are pivotable relative to each other about longitudinal axes. This allows each panel assembly to be folded into a storage or transport configuration, as shown in FIGS. 3 and 6.

FIG. 4 shows the end to end coupling of panel assemblies in more detail. The end edges 100, 102 of confronting panels abut one another along a continuous line. Confronting structural members likewise abut one another. However, the structural members project longitudinally beyond the panels at one end of each assembly, and are recessed longitudinally from the panels at the other end. This offsets the structural member abutment locations 110 longitudinally from the panel abutment locations 112. The result, as seen in FIG. 4, is that the structural members of one assembly protrude longitudinally into the other. This improves the coupling, enhances lateral stability, and ensures a proper lateral positioning of the assemblies to properly align their respective grooves 50.

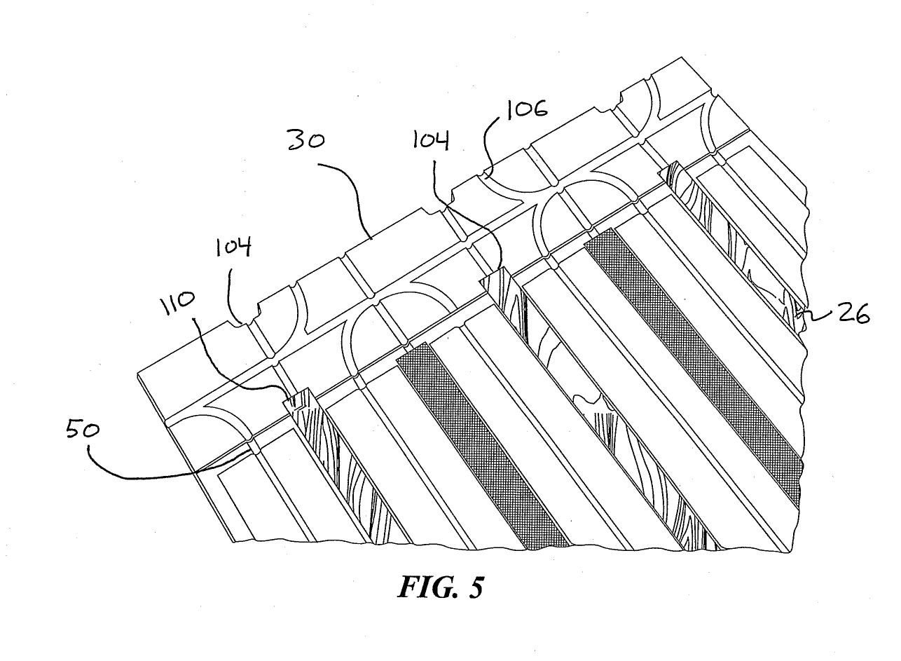

FIG. 5 shows a coupling of a panel assembly 26 and edge panel 30 in greater detail. Structural members 26 project longitudinally into grooves 104 formed in the edge panel, again for an improved coupling, enhanced lateral stability, and accurate lateral positioning to align the arcuate grooves 106 of edge panel 30 with the linear grooves 50 of panels 26. On the panel assembly end where the structural members are recessed, the edge panel can be attached using any conventional securing means, including adhesive, screws or the like.

FIGS. 3 and 6 shows two panel assemblies in the folded configuration, and aligned with one another to minimize the required storage space. More particularly, the panels of one panel assembly include three panels (upper panel plus a pair of panels below) that project laterally beyond the other panels of that assembly, to the right as viewed in FIGS. 3 and 6. This is due to the manner in which the panel assembly is folded to accommodate the structural members. Similarly, three panels of the other panel assembly project laterally (in this case to the left) beyond the remaining panels of the assembly. The projecting panels of one assembly align with the recessed panels of the other, forming a space saving “tongue and groove” engagement.

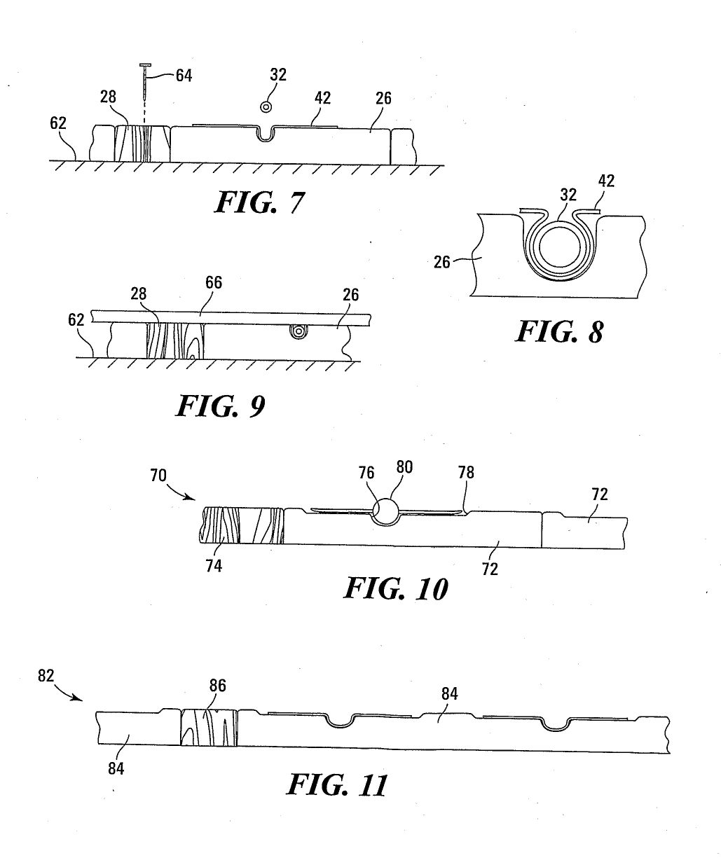

As shown schematically in FIG. 7, installation of a radiant heating system utilizing the panel assemblies involves selectively positioning one of the panel assemblies in the working configuration on a subfloor 62. Then, fasteners 64 are preferably installed through the structural members 26 and into the subfloor to secure the panel assembly in place. The fasteners 64 may be nails, wood screws or concrete fasteners, or adhesive depending on the subfloor. An advantage of the present invention is that when fasteners 64 are used, the fasteners are installed only through the structural members, which are constructed to withstand the concentrated holding forces of the fasteners. There is no need to install fasteners through the panels, nor is there any need to apply an adhesive to the panel of reverse surfaces or subfloor 62.

In addition to the panel assemblies, edge panels 30 are installed typically along the walls of the room and properly aligned with the panel assemblies to form the desired serpentine path for the heated water tubing. Strips 46 are used to couple adjacent panel assemblies side-by-side. End-to-end couplings are as shown in FIG. 4.

Once the panel assemblies and edge panels are secured, tubing 32 is installed into channels 56 along the panel assemblies and arcuate grooves along the edge panels. Linear grooves in the edge panels accommodate supply section 34 and return section 38. The tubing is gently pressed downwardly into the channels, undergoing a slight elastic deformation as it enters the channels, resulting in containment within the channel as illustrated in FIG. 8.

Finally, a cover or finished floor layer 66, such as carpeting, tile, wood, etc., is installed over the panel assemblies and edge panels, as shown in FIG. 9. Depending on the type of flooring involved, finished layer 66 may be secured in any conventional manner to the panel assemblies and edge panels. For wood flooring, as an example, the wood flooring boards are preferably installed in the lateral direction, i.e. with the boards perpendicular to the panels and structural members. Fasteners can be driven through the finished layer into the structural members, which provide a reliable anchor for the finished layer.

FIG. 10 illustrates part of an alternative embodiment panel assembly 70 designed for electrical heating. Panels 72 and structural members 74 are pivotally attached to one another by flexible adhesive backed strips as before. Each of panels 72 has a longitudinal groove 76 in its obverse surface 78, sized to accommodate an electric heating element 80 in the form of an electrically conductive cable surrounded by an electrically insulative, thermally conductive casing. A fabric mat or sheet partially holding the heating element extends laterally away from groove 76.

FIG. 11 illustrates a further alternative embodiment in the form of a rigid panel structure 82. Adjacent panels 84 and structural members 86 are integrally coupled to one another, for enhanced lateral stability. The panels and structural members are not foldable, and remain fixed in the working configuration. However, panel structure 82 retains the advantages associated with combining the more thermally insulative panels with the stronger structural members.

Although only exemplary embodiments of the invention have been described in detail above, those skilled in the art will readily appreciate that many modifications are possible without materially departing from the novel teachings and advantages of this invention. Accordingly, all such modifications are intended to be included within the scope of this invention as defined in the following claims.

1. A radiant heating panel assembly, comprising:
a. at least a first thermally insulative panel having an elongate dimension, an obverse panel surface and a reverse panel surface opposite said obverse panel surface wherein said obverse surface has a groove extending longitudinally along said elongate dimension of said first thermally insulative panel;
b. at least a first radiant heating element comprising a plate defining a longitudinal channel received within said groove of said first thermally insulative panel;
c. at least a first structural member having an elongate dimension and having an obverse structural member surface and a reverse structural member surface opposite said obverse structural member surface; and
d. at least a first coupling structure coupling said first thermally insulative panel to said first structural member such that said elongate dimension of said first thermally insulative panel and said elongate dimension of said first structural member are substantially parallel wherein said obverse panel surface of said first thermally insulative panel and said obverse structural member surface of said first structural member are configured to operably engage a generally planar surface in a side-by-side relationship.

2. The radiant heating panel assembly according to claim 1 wherein said first thermally insulative panel has a first elongate side section hingedly coupled to said first structural member by said first coupling structure and a second elongate side section is coupled to a second thermally insulative panel.

3. The radiant heating panel assembly according to claim 1 wherein said first coupling structure hingedly couples said obverse panel surface of said first thermally insulative panel to said obverse structural member surface of said first structural member.

4. The radiant heating panel assembly according to claim 1 wherein said first coupling structure hingedly couples said reverse panel surface of said first thermally insulative panel to said reverse structural member surface of said first structural member.

5. The radiant heating assembly according to claim 1 wherein a second thermally insulative panel is coupled to said first structural member such that said first structural member extends between said first thermally insulative panel and said second thermally insulative panel, said second thermally insulative panel having an elongate dimension, an obverse panel surface and a reverse panel surface opposite said obverse panel surface includes a radiant heating element received thereon.

6. The radiant heating panel assembly according to claim 5 wherein said second thermally insulative panel is hingedly coupled to said first structural member via a second coupling structure extending from said reverse panel surface of said first structural member to said reverse panel surface of said second thermally insulative panel.

7. The radiant heating panel assembly according to claim 6 wherein said first coupling structure and said second coupling structure comprise a flexible material.

8. The radiant heating panel assembly according to claim 7 wherein said first coupling structure is a first end of said flexible material and said second coupling structure is a second end of said flexible material.

9. The radiant heating panel assembly according to claim 1 wherein said first structural member projects longitudinally beyond said first thermally insulative panel at one longitudinal end thereof, forming an offset abutment location.

10. The radiant heating panel assembly according to claim 9 wherein a second radiant heating panel assembly is longitudinally aligned and configured to receive said offset abutment location in a longitudinally recessed location defined by said second radiant heating panel.

11. The radiant heating panel assembly according to claim 9 wherein said first structural member is recessed longitudinally with respect to an opposing longitudinal end of said first thermally insulative panel.

12. A radiant heating panel assembly, comprising:
a first thermally insulative panel and a second thermally insulative panel each hingedly coupled to opposing longitudinal sides of a structural member such that said radiant heating panel assembly is selectively configurable in a foldable arrangement wherein a first surface of said first thermally insulative panel is in contact with at least a portion of a corresponding first surface of said second thermally insulative panel, said assembly being adjustably configurable in an unfolded arrangement wherein said first thermally insulative panel, said structural member and said second thermally insulative panel are each arranged to simultaneously engage separate sections of a generally planar surface.

13. The radiant heating panel assembly from claim 12 wherein said first thermally insulative panel and said second thermally insulative panel each include a radiant heating element on one surface thereof, said radiant heating element comprising a plate defining an elongate channel extending along a longitudinal length of said radiant heating element.

14. The radiant heating panel assembly from claim 13 wherein said first thermally insulative panel and said second thermally insulative panel each include a shallow recess and elongate groove within which said heating element is received

15. The radiant heating panel assembly from claim 12 wherein a tubing for conducting heated water therethrough is received within said elongate channel of said radiant heating element.

16. A method for installing a radiant heating system comprising the steps of:
a. providing a panel assembly composed of elongate members hingedly coupled side by side, wherein said elongate members include one or more thermally insulative panels and one or more structural members; and
b. selectively positioning said panel assembly in a working configuration against a generally planar surface with reverse surfaces of said elongate members confronting and contiguous with the generally planar surface and with obverse surfaces of said elongate members facing away from the generally planar surface.

17. The method from claim 16 wherein said structural members have a longitudinally extending portion, extending beyond a longitudinal end of said thermally insulative panels.

18. The method from claim 17 wherein said longitudinally extending portion of said structural members is received within a longitudinally recessed portion of a longitudinally aligned panel assembly.

19. The method from claim 17 wherein said longitudinally extending portion of said structural members is received within a recessed portion of an edge panel.

20. The method from claim 19 wherein said edge panel is positioned such that an arcuate groove in said edge panel has a first end in alignment with a channel of one thermally insulative panel and a second end in alignment with a channel of another thermally insulative panel.

21. The method from claim 16 wherein fasteners are installed through said one or more structural members.

22. The method from claim 21 wherein radiant heating elements are mounted along obverse surfaces of said one or more thermally insulative panels.

23. The method from claim 22 wherein a tubing is received within a channel defined by said radiant heating elements.

24. A radiant heating system, comprising:
a. a plurality of thermally insulative panels each being elongate in a longitudinal dimension and having an obverse panel surface and a reverse panel surface opposite said obverse panel surface wherein said obverse surface is contoured to accommodate a radiant heating element and including an elongate longitudinal channel;
b. at least one structural member being elongate in a longitudinal dimension and having an obverse structural member surface and a reverse structural member surface opposite said obverse structural member surface wherein said structural member is coupled to at least one thermally insulative panel, said structural member having a longitudinally projecting portion extending beyond said thermally insulative panel at a longitudinal end thereof; and
c. at least one edge panel having a receiving groove for receiving said longitudinally projecting portion of said structural member, said edge panel having an obverse panel surface and a reverse panel surface opposite said obverse panel surface wherein said obverse panel surface includes an arcuate groove configured such that a first end of said arcuate groove is in operable alignment with the elongate longitudinal channel of one thermally insulative panel and a second end of said arcuate groove is in operable alignment with the elongate longitudinal channel of another thermally insulative panel.
